(19) United States
(12) Patent Application Publication
(10) Pub. No.: US 2015/0186822 A1
(43) Pub. Date: Jul. 2, 2015

(54) System and method for optimal receiving and processing of work for field agents via web-based or mobile applications

(71) Applicants: Joshua Blair Thomas, Cranford, NJ (US); Johann Bent, Piscataway, NJ (US)

(72) Inventors: Joshua Blair Thomas, Cranford, NJ (US); Johann Bent, Piscataway, NJ (US)

(21) Appl. No.: 14/513,078

(22) Filed: Oct. 13, 2014

Related U.S. Application Data
(60) Provisional application No. 61/890,318, filed on Oct. 13, 2013.

(51) Int. Cl. G06Q 10/06; H04L 29/06; H04L 29/08

(52) U.S. Cl. CPC G06Q 10/06311; H04L 67/02; H04L 67/10; H04L 67/42

(57) ABSTRACT

A web-based portal and/or mobile application that receives a project request for a document and/or record. The request may be for records pertinent to the person of interest denoted on the request exist, for example a criminal record. These requests will typically be made when remote online database access is not available. The web-based portal and/or mobile application may also be used to retrieve other legal documents, medical documents, or other documents not reachable through remote electronic means. The web-based portal and/or mobile application provides available and/or offering work to a field agent. The field agent goes to a courthouse and/or municipality and retrieves the document(s). The field agent may then upload picture(s) and/or file(s) via the web-based portal and/or mobile application. Alternatively or in combination, the field agent closes the order with a result such as clear, hit, or other. The mobile application and/or web-based portal may then send the completed project to the client.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### TECHNICAL FIELD

The present disclosure relates generally to a system and method for offering projects, and, more particularly, to receiving projects from clients, offering projects to field agents, and receiving projects from field agents.

### BACKGROUND OF THE INVENTION

Some court houses and/or municipalities allow for external parties to remotely access an online database that maintains public court records. However, not all court houses and/or municipalities are connected to these online databases or only certain documents are retrievable through online databases. Additionally, some court houses and/or municipalities disallow online remote access to external parties for various reasons, including data security concerns. Instead court runners and/or field agents need to retrieve these documents by physically visiting court houses and/or municipalities.

The current methods for assigning work to and receiving completed work from court runners and/or field agents is extremely manual (facsimile/static posted job listing) and does not allow for routing optimization, progress management, or progress transparency. This lack of process control leads to long and inconsistent delivery timelines of necessary information.

### BRIEF SUMMARY OF THE INVENTION

A system and method for receiving a project from a client and dispensing the project to one or more field agents. The project is dispensed to the one or more field agents based on the field agent's location and/or other characteristics of each field agent. The system and method further receive a completed project from the field agent. Alternatively, a field agent may send a delay notice if the field agent cannot retrieve the project from the appropriate location, a delay at the location, and/or a delay in uploading the project.

The system may use a web-based application hosted by one or more servers. Alternatively or in combination, the system may use a mobile application. The web-based application and/or mobile application may receive orders from a client. Then determine a number of attributes of the order (order attributes) and compares them with a list of attributes of field agents. The field agent attributes may include location of the field agent, availability of field agent, prior history, etc. The order may then be associated with one or more field agents based on the attributes of the field agents and order attributes. A field agent may then select one or more associated projects (orders) via the web-based portal and/or mobile application. The field agent completes the project and uploads any documents via the web-based portal and/or mobile application. The mobile application and/or web-based portal then supplies the completed project (order) to the client.

### BRIEF DESCRIPTION OF THE SEVERAL VIEWS OF THE DRAWING

The embodiments herein may be better understood by referring to the following description in conjunction with the accompanying drawings in which like reference numerals indicate identically or functionally similar elements, of which:

FIG. 1 illustrates a simplified flow of different entities and/or resources;

FIG. 2 illustrates a simplified process flow diagram between entities;

FIG. 3 illustrates a simplified view of different entities and systems that work in combination with internal system;

FIG. 4 illustrates a flow chart of order processing by internal system;

FIG. 5 illustrates a flow chart of field agent processing a project;

FIG. 6 illustrates an example user interface of a field agent work screen;

FIG. 7 illustrates an example user interface of a field agent open work screen;

FIG. 8 illustrates an example user interface of a field agent completed work screen;

FIG. 9 illustrates a flow chart for a field agent processing a record search; and

FIG. 10 illustrates a flow chart for providing a result to client.

### DETAILED DESCRIPTION OF THE INVENTION

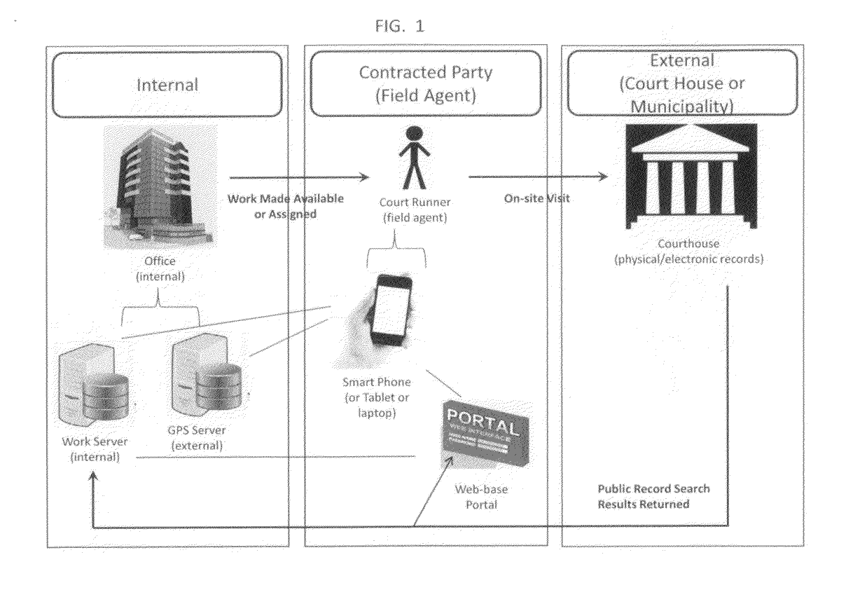

FIG. 1 illustrates a simplified flow chart of involved entities and/or resources. The internal system receives projects and stores the projects on servers. The servers can be internal servers or external servers. The storage space may be part of the internal system or the storage space may be rented space such as cloud storage. The internal system may also include a GPS server or may connect to an external GPS server. The internal system processes projects from clients and organizes the projects based on different characteristics, such as time needed (urgency), location, other projects ongoing, difficulty of project, etc. The servers also host a web-based application and/or mobile application.

The contracted party (contracted field agent) and/or internal field agent uses a portable device such as a smart phone, tablet, laptop, or other similar device that connects to the internet and/or the mobile data network. The portable device must also include a GPS chip. Alternatively, if the mobile device does not include a GPS chip, then the field agent may be located from a GPS chip within a smart phone, non-smart phone, or other GPS enabled device. A web-based portal run by the internal system provides a listing of projects that need to be completed. Some projects may be assigned directly to an internal and/or field agent based on location (using the GPS server and the GPS chip within a device connected to web-based portal and/or mobile application or a device near the field agent). Alternatively or in combination, a project may be assigned to a specific field agent based on a field agent's expertise. Other projects may be suggested for a group of field agents. Then once, one field agent selects the project, then that project is in that field agents assigned list, and removed from associated lists of other field agents.

Alternatively, or in combination with the GPS locator chip, a field agent may select a preferred work area. The preferred work area may include one location or multiple locations and/or a map of a preferred work area. The preferred work area may be used as an attribute in associating work to field agents without using the GPS location. Additionally, the preferred work area may work in combination with a field agent GPS location to associate more projects in certain geographical location. The preferred work area may also assist in associating work to a field agent to increase a field agent's personal relationship with the internal system or in other words make the field agent happier in a certain location.

Once a field agent has an assigned project, then the field agent goes on-site to the court house, municipality building, federal building, or any other location necessary to find to the document to fulfill the project. The document may be a birth certificate, divorce decree, warrant, pleading, etc. The document may be stored electronically at the location or physically at the location.

Once the document is located, the field agent may download the document to an external storage device such as USB storage device. Then the field agent may connect the external storage device to their portable device (smart phone, tablet, laptop, etc.) and upload the document to web-based portal into the internal system or use the mobile application to upload to the internal system. Alternatively, the field agent may use the web-based portal on the computer where the document was located and upload directly to the web-based portal.

If the document is only a physical document, then the field agent may photocopy the document, and bring to the internal system's office. Alternatively or in combination, the field agent may take a picture of the document or use a portable scanner to scan the document. Then the field agent may upload the image using the web-based portal and/or mobile application via their mobile device. Alternatively, the field agent may use local computer in the court house or close to the location of the court house to scan the original document or a photocopy of the document and upload the document using the web-based portal on the local computer.

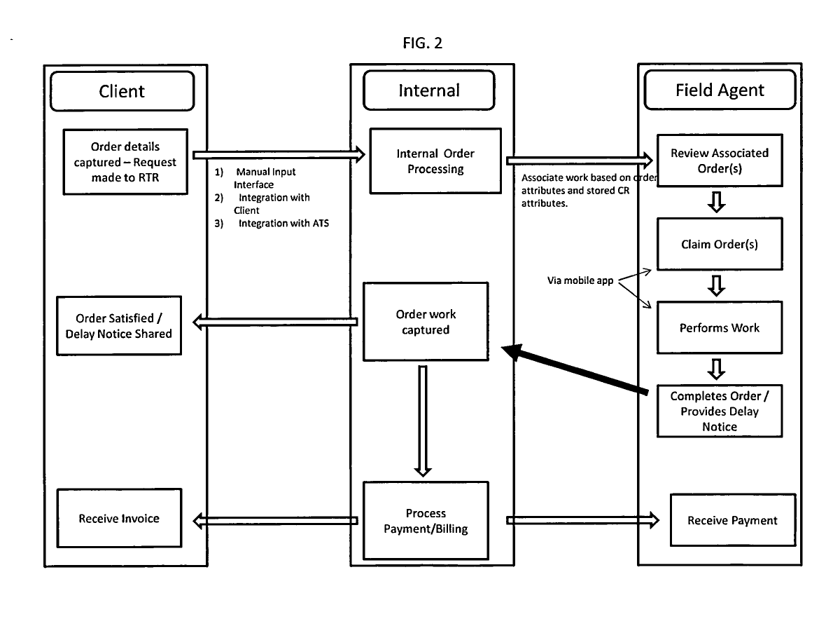

FIG. 2 illustrates the process flow between the client, internal system, and the field agent. A client enters the needed document through a user interface through a website. The client may be a single person or another web service that requires documents that are not reachable electronically. The internal system and/or a third party administrator captures the information necessary to perform the project. The internal system also allows the client to track the progress of the order through an applicant tracking system.

The internal system processes the details of project and creates a set of order attributes. Next, the internal system compares the order attributes with stored field agent attributes to associate projects with one or more field agents. The field agent attributes may include current location, time available, prior history, etc. Next the field agent reviews associated projects and claims one or more associated projects using the portable device. More specifically the field agent may be using a mobile application on the portable device or a web-based portal. The claimed project(s) are then removed from the queue of other associated field agents.

The field agent locates the appropriate document(s) for the project and sends the document to the internal system. Sending the document to the internal system may be completed through a mobile application, the web-based portal, and/or physical drop-off. Alternatively, if the field agent cannot retrieve the document in the necessary time, the field agent may provide a delay notice. This may be because the location is closed or the document is not ready yet, etc.

The internal system received the document and provides the project to the client. If the delay notice is received, the internal system forwards the delay notification to the client.

The internal system then completes the transaction with billing. The client receives an invoice for work completed. The client sends payment to the internal system. The payment may be made directly through the internal system or a third party payment system, for example Paypal®. Further, the internal system sends a payment to the field agent for the completed work. The payment may be made directly to the field agent's account or via a third party payment system.

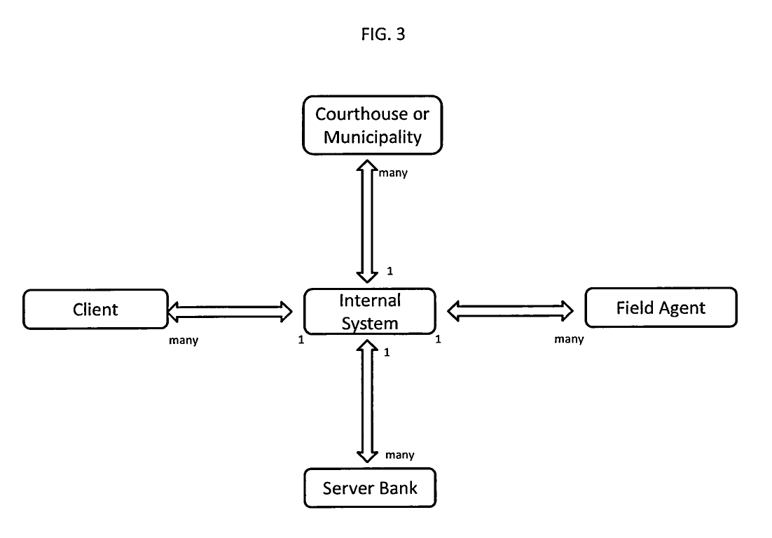

FIG. 3 illustrates the entity relationships. A single internal system can work with multiple clients and multiple field agents. Additionally, the internal system may work multiple courthouses and/or municipalities. The internal system uses one or more server banks to store received orders, received projects, and to host the mobile application and/or web-based portal.

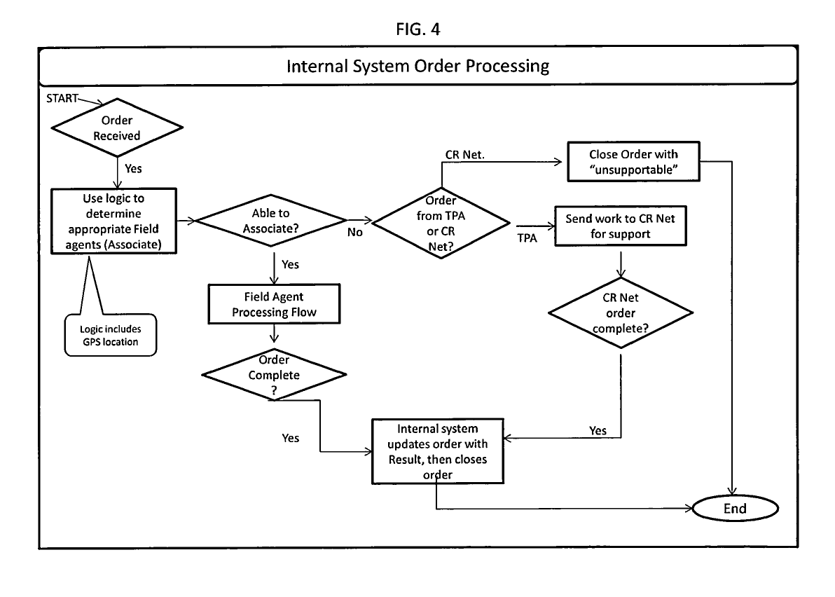

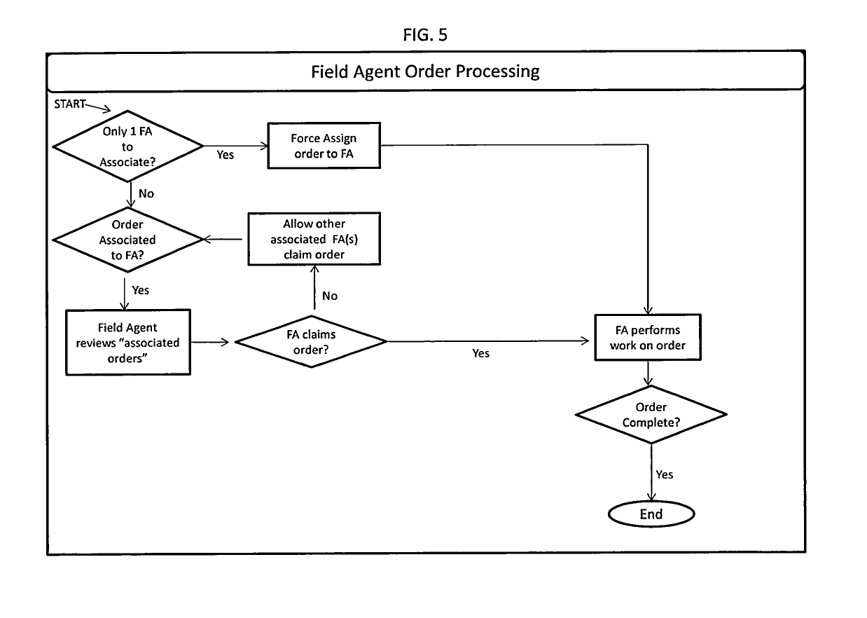

FIG. 4 illustrates a flow chart for order processing. The process starts, once an order is received for a project. Next, the internal system uses logic to determine one or more appropriate field agents to associate with the project. The logic may include GPS location, work active, time available, prior history, etc. If the internal system is able to associate, then go to field agent processing flowchart (FIG. 5). If the internal system is not able to associate, then the system determines who the client is. If the client is a court runner network, then the order is closed with “unsupportable”. If the client is a person or a third party administrator, then the project is sent to another court runner network. If the court runner network completes the project then the project is completed. If the court runner network is not completed then the order is closed with “unsupportable”. The internal system may include a delay in returning results, which may be populated to the client through applicant tracking system.

Once the order is complete either from CR Net or a field agent, then the internal system updates the order with the result and sends the project to the client. The internal system then closes the order.

FIG. 5 is a flowchart of a field agent order processing. The process starts once the internal system associates a project with one or more field agents. If only one field agent is determined to be a good fit for the project, then the one field agent is force assigned the project. That field agent performs the work on the project and the order is complete. If more than one field agent is determined be a good fit for the project, and then the project is sent to multiple field agents as an open order. One or more field agents may review associated projects (orders). If the field agent chooses to complete the project, then the field agent claims the project (order) and performs the work necessary for the project. If the field agent chooses not to claim the order, then other field agents associated with the project may claim the project. The process ends when the project (order) is complete.

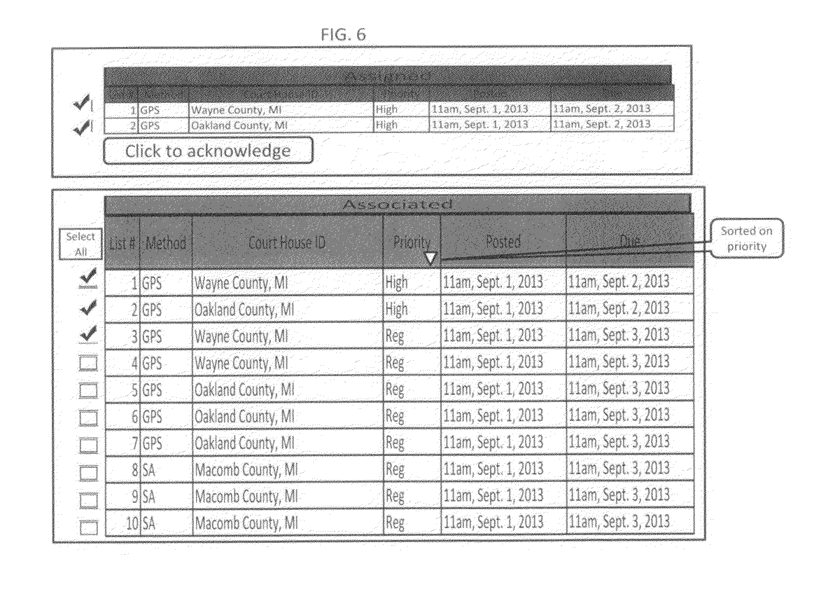

FIG. 6 is an example of a user interface screen for a field agent. The user interface may show assigned project in one grouping and associated projects in another grouping. The associated projects are shown sorted by priority, but the projects may be sorted based on location, courthouse ID, date posted, and/or due date. A field agent then selects one, or more projects from the associated list to claim one or more projects.

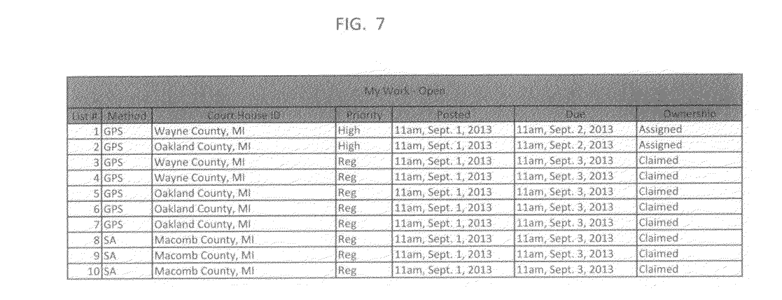

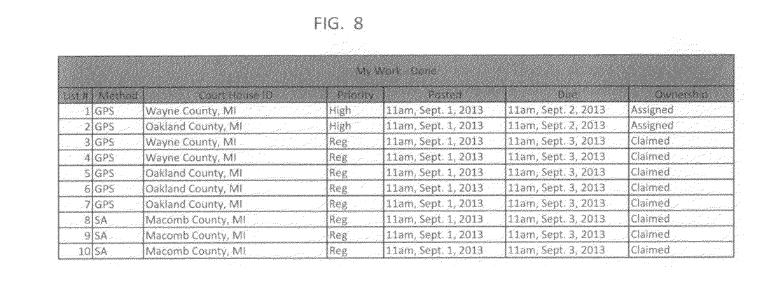

FIG. 7 is an example user interface screen for a field agent showing all open projects or in other words projects that the field agent need to complete. FIG. 8 is an example user interface screen for a field agent showing all closed projects or in other words projects that the field agent has completed.

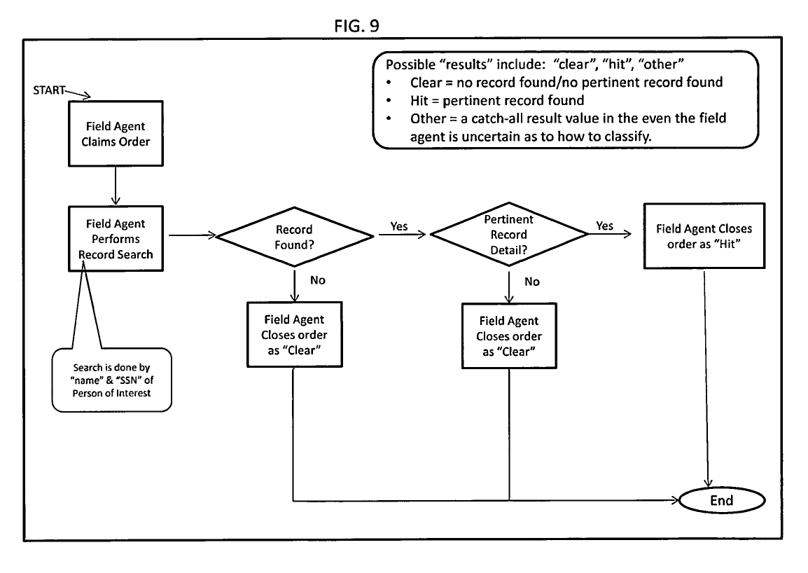

FIG. 9 is a flow chart for a field agent processing a record search. The process starts when a field agent claims an associated project (order). The field agent performs a record search for the project at a court house and/or municipality. The search may be done using the name entered from the client and social security number of the person of interest. If no record is found, then the field agent closes the order as “Clear”. If a record is found by the field agent, then the field agent checks if the record includes pertinent details. If no detail, then the field agent closes the order as clear. If there are pertinent record details, then the field agent closes the order as a “Hit”. The field agent may also update a copy of any pertinent record details found through the mobile application and/or web-based portal.

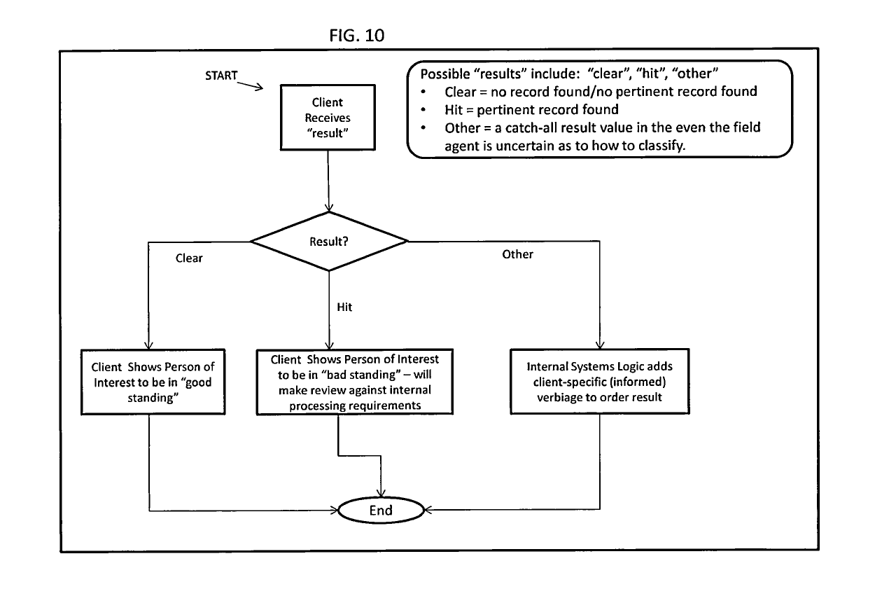

FIG. 10 illustrates a flow chart for providing a result to client. The process starts when the client receives result. If the result is a “Clear”, then the client shows person of interest to be in “good standing.” If the result is a “Hit”, then the client shows person of interest to be in “bad standing” or other similar idea based on review of internal processing requirements. Additionally, the system may also supply a list of pertinent record details. The list of pertinent record details may be supplied right away based on the specifics of the order. The list of pertinent record details may be offered to client for sale. Additionally or in combination a delay of time may be included for client to receive the list of pertinent record details based on parameters specific to the field agent processing the project. If the result is other, then the internal system adds client specific information to the order result based on the information entered by the field agent to classify the result.

It should be noted that while certain steps within procedures in FIGS. 4, 5, 9 and 10 may be optional as described above, the steps shown in FIGS. 4, 5, 9 and 10 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures in FIGS. 4, 5, 9 and 10 are described separately, certain steps from each procedure may be incorporated into each other procedure, and the procedures are not meant to be mutually exclusive.

While the description has been directed to field agents and court houses and municipalities, the same system may be used in other fields. For example, the field agent may retrieve documents from medical facilities and receive authorization through the web portal or mobile application. The system may pick the field agent based on location and/or other attributes and the field agent may upload any documents through the website or mobile application. Alternatively or in combination, the system may be used for assigning projects to runners in a city.

While there have been shown and described illustrative embodiments that provide for receiving and assigning projects to one or more field agents and receiving documents from one or more field agents, it is to be understood that various other adaptations and modifications may be made within the spirit and scope of the embodiments herein. For example, the embodiments have been shown and described herein with relation to mobile devices. However, the embodiments in their broader sense are not as limited, and may, in fact, be used with other types of electronic devices.

The foregoing description has been directed to specific embodiments. It will be apparent; however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

### Definitions

1) Internal (office): refers to the internal operations of the system

2) Courthouse: refers to county, city, state, federal buildings that maintain and/or house public records

3) Court Runner: refers to a field agent that may be a contracted party or internal employee

4) Client: refers to the entity that Internal System is providing a billable service to

5) Smart Phone/Tablet/laptop: refers to an electronic device that can receive/transmit data via mobile, wireless, or wired networks

6) Web-based Portal: refers to a methodology to receive/transmit digital data via internet technology

7) Work Server: refers to an owned or leased computer that houses databases and organized code to facilitate established procedures

8) Server Bank: refers to scalable data storage space that can be provided via lease by an external party

9) GPS Server: refers to service provided by an external party

10) TPA (Third Party Administrator): refers to an entity that provides consolidated data information services

11) TPN (Third Party Network): refers to an entity that provides a specialized service to TPAs

12) Associate: refers to the action taken by Internal Systems logic, or internal personnel, that makes project(s) (order(s)) available to a field agent

13) Assign: refers to the action taken by internal Systems logic, or internal personnel, that assigns project(s) (order(s)) to a field agent

14) Order: refers to a transactional request from a Client to perform work

1. The use of web-based technologies (cloud servers and mobile applications), mobile internet technology hardware (smart phones and tablets), cellular networks, and geo-coding (GPS), combined with process design that informs our proprietary software, comprise our utility (process) invention. Our complimentary packaging of these various web-based and IT resources allows us to emplace process controls on what is currently a very manual, inconsistent, and lacking (in terms of timeliness) industry-wide solution. Key inputs, from the above stated technologies, allows us to optimize routing (akin to the logistics industry), to actively manage progress, and to obtain work in “real-time”, which allows us to compress delivery windows and provide a consistent service.
